(19) United States
(12) Patent Application Publication
(10) Pub. No.: US 2022/0388237 A1
(43) Pub. Date: Dec. 8, 2022

(54) ARRANGEMENT AND METHOD FOR GENERATING A LAYER OF A PARTICULATE BUILDING MATERIAL IN A 3D PRINTER

(71) Applicant: LAEMPE MOESSNER SINTO GMBH, BARLEBEN (DE)

(72) Inventors: IVAN GAER, SCHOPFHEIM (DE); JANOSCH MUENZER, ZELL IM WIESENTAL (DE); FRANK WEDEMEYER, ZELL IM WIESENTAL (DE); RUDOLF WINTGENS, SCHOPFHEIM (DE)

(21) Appl. No.: 17/754,936

(22) PCT Filed: Oct. 23, 2020
(86) PCT No.: PCT/DE2020/000254

§ 371 Date: Apr. 15, 2022

(30) Foreign Application Priority Data
Oct. 26, 2019 (DE) 10 2019 007 480.7

(51) Int. Cl. B29C 64/153; B33Y 10/00; B33Y 30/00; B29C 64/214; B29C 64/218

(52) U.S. Cl. CPC B29C 64/153; B33Y 10/00; B33Y 30/00; B29C 64/214; B29C 64/218

(57) ABSTRACT

Arrangement and method for generating a layer of a particulate building material in a 3D printer in which a quantity of applied material is increased while keeping the quality constant and forces acting on the construction site during application, smoothing and compacting of the particulate building material is reduced. The arrangement includes: a first assembly having a device for applying the particulate building material to a construction site moveable thereover; a second assembly spatially separate from the first assembly and which has a device for smoothing the applied particulate building material. In terms of the method: in a first step, applying the particulate building material to the construction site with the arrangement above and movable over the construction site; and in a second step, following in time and independent of the first step, smoothing the applied particulate building material, the first and second steps performed in a single movement.

The invention relates to an arrangement for generating a layer of a particulate building material in a 3D printer, in which arrangement at least one means for applying particulate building material and one means for smoothing particulate building material are arranged.

The invention also relates to a method for generating a layer of a particulate building material in a 3D printer, wherein a particulate building material is applied, smoothed and compacted to generate a layer.

It is known to use a so-called 3D printing or a so-called 3D printing process for the production of individual or series components, workpieces or molds. In such printing processes, three-dimensional components or workpieces are generated layer-by-layer.

The structure is assembled under computer control from one or more liquid or solid materials according to specified dimensions and shapes. Specifications for the components or workpieces to be printed can be provided, for example, by so-called computer-aided design systems (CAD).

When printing the 3D structures or 3D components, physical or chemical hardening processes or a melting process take place in a particulate building material, which is also referred to as molding material. Building materials or molding materials such as plastics, synthetic resins, ceramics and metals are used as materials for such 3D printing processes.

Various manufacturing process sequences are known for implementing 3D printing processes.

However, several of these process sequences include the following exemplary process steps:
Partial-surface or full-surface application of particulate building material, also referred to as particulate material or powdered building material, on a so-called construction site in order to form a layer of non-solidified particulate material;
Selective solidification of the applied layer of non-solidified particulate building material in predetermined partial areas, for example by selective compacting, printing or application of a treatment agent, such as a binder or use of a laser;
Repetition of the previous process steps in a further layer level for the layered construction of the component or workpiece. For this purpose, the component or workpiece, which is built up or printed at the construction site layer-by-layer, is lowered together with the construction site by one layer level or layer thickness, or the 3D printing device is raised by one layer level or layer thickness compared to the construction site before a new layer is applied over part of the surface or over the entire surface;
Subsequent removal of loose, non-solidified particulate build material surrounding the manufactured component or workpiece.

Various methods for generating a 3D structure or for applying particulate building material on a construction site to generate a 3D structure are known in the prior art.

A method and a device for applying fluids and their use are known from DE 10117875 C1.

The method of applying fluids relates specifically to particulate material being applied to an area to be coated, wherein the fluid is applied to the area to be coated in front of a blade, as viewed in the direction of advancement of the blade, whereafter the blade is moved across the applied fluid.

The object is to provide a device, a method and a use of the device capable of achieving a very even distribution of fluid material on an area to be coated.

With the proposed solution, the blade performs an oscillation similar to a rotary movement. The oscillating rotary movement of the blade fluidizes the fluid applied to the area to be coated. As a result, not only can particulate material with a strong tendency for agglomeration be applied as evenly and smoothly as possible, but the vibration can also influence the compression of the fluid.

In a preferred embodiment, excess fluid can be applied to the area to be coated, so that the constant movement of the blade, which oscillates in the manner of a rotary movement, causes the excess fluid in front of the blade, as viewed in the movement direction of the advancing blade, to be homogenized in a roller formed by the fluid/particulate material as a result of the advancement of the blade. This allows any voids between individual clumps of particles to be filled and larger clumps of particulate material to be broken up by the roller movement.

DE 10 2016 211 952 A1 discloses a coating unit, a coating method, and a device and a method for the additive manufacturing of a three-dimensional object.

The problem to be solved is to provide an alternative or improved coating unit or production device or an alternative or improved coating or production method for a three-dimensional object by applying and selectively solidifying a construction material layer-by-layer, wherein in particular the coating direction can be easily changed.

To solve this problem, the coating unit contains at least two coating rollers that are spaced apart from one another in a first direction and extend in a second direction transversely to, preferably perpendicularly to, the first direction, and a compression and/or smoothing element that is arranged in the first direction between the two coating rollers and extends in the second direction.

The coating unit is designed, depending on the direction of movement of the coating unit in the first direction or in its opposite direction, to draw out building material with the coating roller leading in the respective direction of movement into a uniform layer, and to compact and/or smooth with compacting and/or smoothing element the layer that was drawn out with the leading coating roller. With such a coating unit, for example, application and compression and/or smoothing of a material layer can be effected separately from one another by separate elements, while the coating unit can still be used in mutually opposite coating directions.

The compression and/or smoothing element is preferably arranged essentially centrally between the two coating rollers in the first direction.

DE 10 2006 023 484 A1 discloses a device and a method for producing a three-dimensional object in layers from a powdered construction material. In particular, the invention relates to a method of selective laser sintering and a laser sintering apparatus.

The object is to provide a method and an apparatus for producing a three-dimensional object, in particular a laser sintering method and a laser sintering apparatus, which enable a reduced refresh rate and which lowers the costs of the process.

For this purpose, the coater has a blade with an application surface that rises in the coating direction, with the application surface being provided on the underside of the blade facing the support and rising at an angle of greater than 0.2° and less than about 5°, preferably between about 0.5° and about 3°, more preferred between about 0.7° and about 2.8° in the direction of movement of the coater. With this blade, smoothing and compacting can be achieved simultaneously after the material has been applied.

According to the state of the art, the application of the particulate building material, the stripping or smoothing and the compacting of the building material are carried out by a device or by an arrangement. This includes at least a means for applying the particulate building material and a means for stripping or smoothing and compacting the building material, which is usually designed as an element in form of a blade, which form a device or an arrangement constructed as a spatial or structural unit. According to the prior art, the installation space for such devices or arrangements is also supposed to be kept small.

An arrangement according to the prior art with a so-called oscillating blade, which solves the process steps of applying, smoothing and compacting the particulate building material in combination, disadvantageously requires a higher oscillating frequency of the oscillating blade when the quantity of applied material is increased. At this higher oscillation frequency, a greater quantity of particulate building material can be discharged and this greater quantity of the discharged particulate construction material can be compacted.

However, there are physical limits to increasing the oscillation frequency of the oscillating blade. This limitation applies equally to the process steps application, smoothing and compacting.

Due to the higher oscillating frequency of the oscillating blade and a high feed rate, a larger quantity of particulate building material slides or slips under the oscillating blade and damages the already created printed image underneath or the already partially created 3D structure.

In addition, the excess material, which forms a so-called mountain in front of the oscillating blade and is caused by an excess of applied particulate building material, cannot be kept to a minimum due to the direct relationship between application, smoothing and compaction, without affecting one of the secondary functions of the oscillating blade.

Likewise, it is not possible to use the oscillating blade individually for just one of its tasks.

Based on this prior art, there is a need for an improved arrangement and method for generating a layer of particulate building material in a 3D printer.

The object of the invention is therefore to specify an arrangement and a method for generating a layer of a particulate building material in a 3D printer, which enables an increase in the quantity of the applied material while also maintaining a constant quality and a reduction in the forces acting at the construction site during application, smoothing and compacting of the particulate building material.

The object is achieved by an arrangement with the features according to patent claim 1 of the independent patent claims. Further embodiments are recited in the dependent patent claims.

The object is also achieved by a method with the features according to patent claim 8 of the independent patent claims. Further embodiments are recited in the dependent patent claims.

The invention provides that in the arrangement for generating a layer of a particulate building material in a 3D printer, which is also simply referred to hereinafter as a coater or coater arrangement, the means for applying the particulate building material is spatially separated from the means for stripping or smoothing and compacting the building material. In addition, the means for applying the particulate building material is also technically or functionally separated from the means for stripping or from a means for smoothing and compacting the building material.

Accordingly, at least one means for applying the particulate building material and at least one means for stripping or smoothing the applied particulate building material are both arranged in the coater arrangement that can be moved over the construction site. When the coater arrangement is moved over the construction site, the means arranged in the coater arrangement also move with the coater arrangement. When the means are arranged at a specific distance from one another in the coater arrangement, this specific distance between the means may be maintained during the movement of the coater arrangement over the construction site. In one embodiment, the means may be firmly connected to the coater arrangement at a specific distance from one another during a production step of the coater arrangement.

The physical separation of the means prevents the means from mutually influencing each other. The technical separation allows each means to be controlled or regulated separately and independently of another means.

A particle-shaped building material is generally understood to be a collection of individual particles of a substance or a substance mixture, with each particle having a three-dimensional extent. Since these particles can predominantly be understood as being round, oval or elongated particles, an average diameter can be defined for such a particle, which is usually in the range between 0.1 mm and 0.4 mm. Such a particulate building material has fluid properties.

The particulate building material may be applied to a construction site, for example via a roller or alternatively via a rounded edge. The particulate building material is spread over this construction site and is subsequently smoothed by a means which has at least one blade and which is arranged spatially separate from the roller or edge.

In one embodiment, the blade may smooth and compact the particulate building material.

In an alternative embodiment, the particulate building material may be compacted by a further means for compacting that is independent of the blade and independent of the roller or rounded edge.

When smoothing the particulate building material, the excess applied particulate building material, which is intended to ensure a uniformly filled construction site, creates a so-called “mountain” or excess material. The height of this mountain depends on the quantity of the material applied, for example, via the roller and can thus be set, for example, via a speed of the roller.

Advantageously, the excess material or mountain may be kept as small as possible, since in this way the forces acting on the already generated printed image below or on the already partially generated 3D structure become smaller when the building material is smoothed.

The more uniform the application of the building material over the entire dispensing width of the roller, the smaller becomes the mountain in front of the blade.

Furthermore, a first subassembly with a means for applying the particulate building material to a construction site and in a second subassembly, which is arranged spatially and technically apart from the first subassembly, a means for smoothing the applied particulate building material may be arranged in the coater arrangement. Thus, both the first subassembly and the second subassembly are arranged in a coater arrangement, with the subassemblies moving along with the coater arrangement over the construction site since they are coupled to the coater arrangement. In this way, both a spatially separate arrangement of the various means and a possibility of changing the distances between the various means within the coater arrangement are created.

The distances between the different means in der coater arrangement may be specified by the structure. Alternatively, a means for changing the distances during operation of the 3D printer may be provided, whereby, for example, the distances can be adapted to different particulate building materials or print qualities to be achieved.

With the technical and thus spatial separation of the means within the coater arrangement, the process steps of applying the particulate building material, smoothing the particulate and compacting the particulate building material advantageously do not affect each other, although these process steps are carried out in a single movement of the coater arrangement over on the construction site. Such a mutual influence takes place, for example, in a prior art method with an oscillating blade, since the oscillating blade applies, smooths and compacts at the same time. According to the invention, the process parameters of the respective work steps of application, compaction and smoothing can be matched to one another and regulated independently of one another.

Furthermore, they can also be combined in a control loop.

A means for applying the particulate building material and a plurality of means for smoothing the applied particulate building material may be arranged in the coater arrangement. By dividing the smoothing process over a number of sub-assemblies, such as a number of blades, the forces acting on an already created 3D structure that lies underneath the layer to be currently generated can be reduced. This has an advantageous effect on the quality of the generated 3D structure.

A first means for applying particulate building material and a first means for smoothing the applied particulate building material and a second means for applying particulate building material and a second means for smoothing the applied particulate building material may be arranged in a coater arrangement.

With a multiple arrangement of such means in the order listed, different particulate building materials can be applied to the construction site in a single movement of the coater arrangement over the construction site. Furthermore, a layer consisting of two different partial layers can be applied, wherein the partial layers may consist of the same particulate building material or of different particulate building materials.

Furthermore, the means for applying the particulate building material to the construction site may be a roller with a corresponding associated storage container and means for metering the building material.

Furthermore, the means for smoothing the particulate building material may be a blade or a squeegee.

Due to the spatially separate arrangement of the means for applying the particulate building material from the means for smoothing the applied particulate building material within a coater arrangement, the associated process steps of application and smoothing take place sequentially during a movement of the coater arrangement over the construction site. Thus, after the particulate building material has been applied, the particulate building material rests for a certain time before it is smoothed. This rest time has a beneficial effect on the quality when generating a layer as well as on the quality of the generated 3D print.

When the layer is produced, at least a first partial layer and a second partial layer are advantageously applied in a single movement of the coater arrangement over the construction site, with the thickness of the layer being the sum of the partial layer thicknesses. A limitation to only two sub-layers in the layer is not contemplated.

In addition to the features already described, the applied and smoothed particulate material may be compacted. This method step can be implemented with the means for smoothing the particulate building material or with a separate means for compacting.

After an application of the particulate building material according to the invention, a process step follows wherein the applied layer of non-solidified particulate building material is selectively solidified in predetermined partial areas. This process step is not relevant for the present invention and will therefore not be explained here in detail.

Methods known from the prior art, such as solidification by printing or application of treatment agents, such as a binder, or the use of a laser, are possible.

The aforedescribed features and advantages of this invention will be better understood and appreciated after a careful study of the following detailed description of preferred non-limiting exemplary embodiments of the invention in conjunction with the accompanying drawings, which show in:

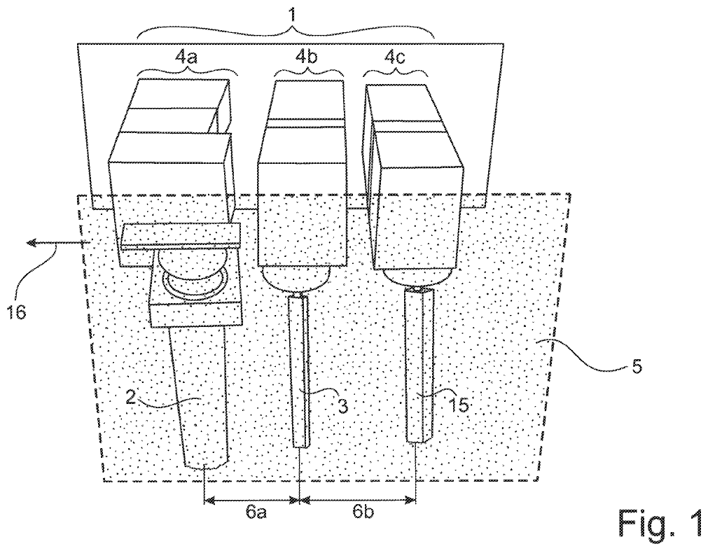

FIG. 1: a perspective exemplary representation of the arrangement according to the invention in a first embodiment,

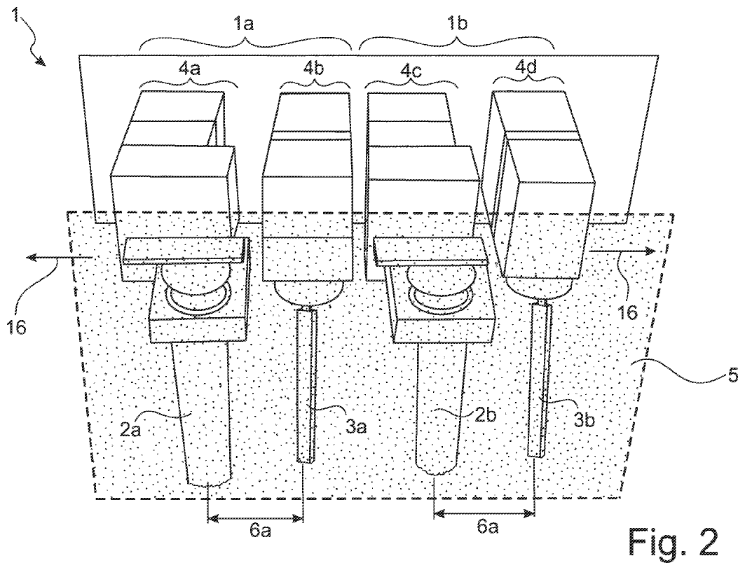

FIG. 2: a perspective exemplary representation of the arrangement according to the invention with two means for applying and two spatially separate means for smoothing particulate building material,

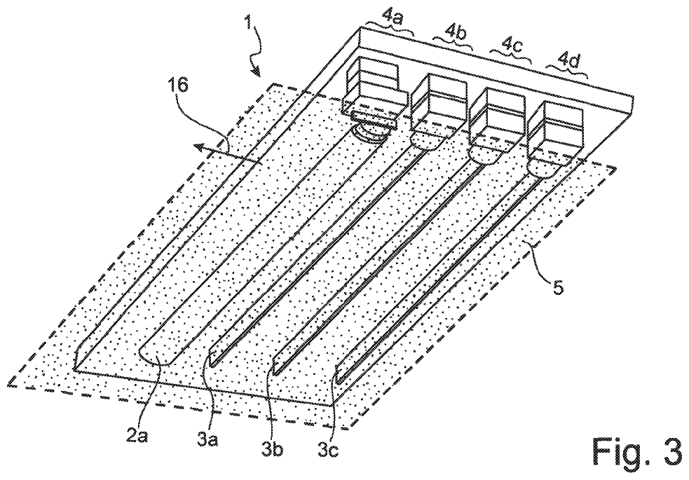

FIG. 3: a perspective exemplary representation of the arrangement according to the invention with a means for applying and a plurality of spatially separate means for smoothing particulate building material,

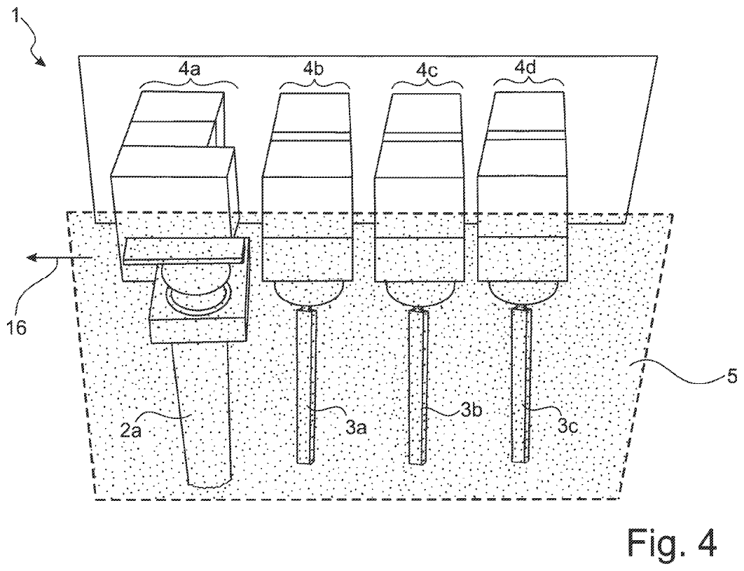

FIG. 4: a further representation of the arrangement of FIG. 3,

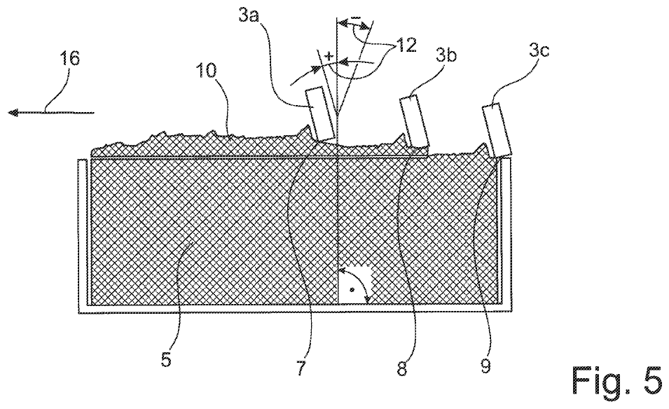

FIG. 5: a schematic representation of the operation of several means for smoothing particulate building material, and

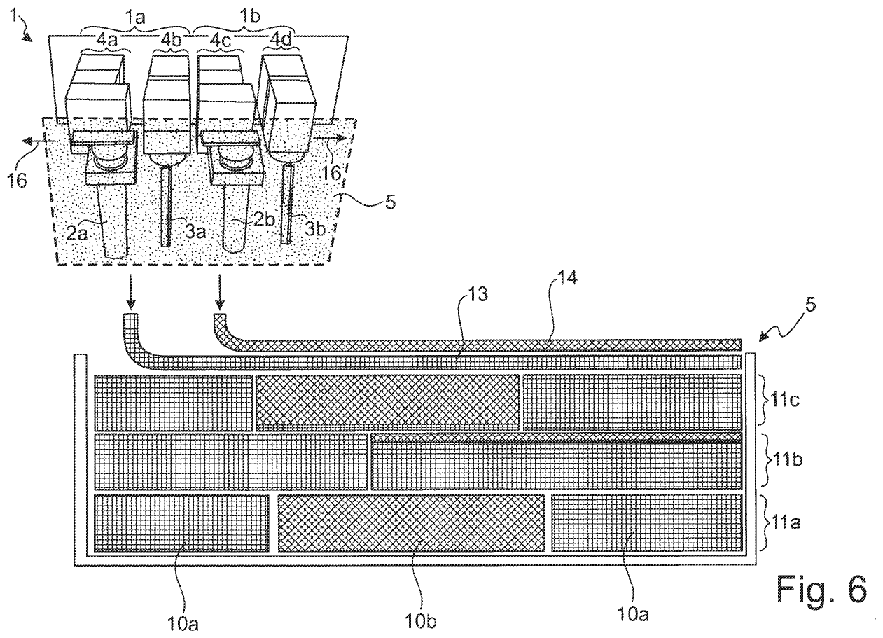

FIG. 6 two spatially separate arrangements according to the invention, each with a means for applying and a means for smoothing particulate building material across a construction site.

FIG. 1 shows a perspective exemplary representation of the arrangement 1 according to the invention with a means 2 for applying and a spatially separate means 3 for smoothing a particulate building material 10, not shown in FIG. 1, in a first embodiment in a viewing direction obliquely from below onto the arrangement 1. The means 2 may be designed, for example, as a roller and the means 3 may be designed, for example, as a blade or a squeegee. The arrangement 1 also has a means 15 for compacting the applied and smoothed building material 10. The means 15 may also be designed as a blade, for example. The following figures do not show the means 15 for compacting the applied and smoothed building material 10.

The arrangement 1 or the coater arrangement 1 has a means 2 for applying a particulate building material 10 and a means 3 for smoothing the particulate building material 10, with the means 2 being arranged in an assembly 4a and the means 3 being arranged in an assembly 4b spatially separate from the assembly 4a. The means 15 for compacting the applied and smoothed building material 10 is arranged in an assembly 4c spatially separate from the assemblies 4a and 4b.

The assemblies 4a, 4b and 4c have components such as holding elements, drives, sensors, actuators and others, which are necessary for the proper functioning of the corresponding assembly 4a, 4b and 4c. For example, a storage container for the particulate building material 10 is also provided in the assembly 4a, as well as a cylinder or roller, via which the particulate building material 10 is placed on a construction site 5, which is shown in FIG. 1 and in the following figures only schematically by an area framed by a dash-dash line. Other components of the assemblies will not be explained here further, since they can be arbitrarily interchanged and are not essential for the present invention.

The distance 6a between the means 2 and the means 3 and the distance 6b between the means 3 and the means 15 in FIG. 1 can each be adjusted independently of one another.

The arrow 16 illustrates the direction in which the arrangement 1 is moved over the construction site 5 when the particulate construction material 10 is applied.

FIG. 2 shows in a further embodiment a perspective exemplary representation of the spatially separate arrangement 1 according to the invention for generating a layer 11 of a particulate building material 10 in a 3D printer in a viewing direction oblique from below the arrangement 1.

The arrangement 1 or the coater arrangement 1 has a first means 2a for applying the particulate building material 10 (not shown in FIG. 2) and a first means 3a for smoothing the particulate building material 10. The first means 2a is arranged in an assembly 4a. The first means 3a is arranged in an assembly 4b which is spatially separate from the assembly 4a. The means 2a and 3a may be arranged at the same distance from the surface of the construction site 5 and may be movable with the coater arrangement 1 in an imaginary plane over the construction area 5.

The assembly 4a has at least one means 2a for applying the particulate building material 10.

The assembly 4b has at least one means 3a for smoothing the previously applied particulate building material 10.

The coater arrangement 1 is arranged above a construction site 5 over which the coater arrangement 1 can be moved in the directions shown by the two arrows 16. The means required for moving and guiding the coater arrangement 1 are not shown in FIG. 2. According to the example in FIG. 2, the coater arrangement 1 can be moved to the right and to the left, but in the illustrated embodiment only one direction of movement to the left is provided when generating a layer 11 of the particulate building material 10, since the means 2a must be arranged in front of the means 3a as viewed in the direction of movement. However, a restriction to the example in FIG. 2 is not intended.

In an embodiment in which the arrangement of the assemblies 4c and 4d is interchanged within the coater subassembly 1b, the coater assembly 1 can be used in both directions to generate in each direction a respective layer 11 of the particulate building material 10.

Thus, in a direction of movement to the left, the coater subassembly 1a is used, and in a direction of movement to the right, the coater subassembly 1b is used to generate a layer 11.

In the embodiment of FIG. 2, too, the means 2a and 3a can be arranged in the coater arrangement 1 at an adjustable distance 6a from one another. This distance 6a, when viewed from the center axis of one means to the center axis of the adjacent means, is in a range between 10 mm and 150 mm, in particular in a range between 40 mm and 100 mm. This distance 6a is specified by the technical design (type of application, type of smoothing, type of compression) and is designed to be as small as possible in order to keep the resulting additional travel as small as possible. The same dimensional ranges as for the distance 6a may apply to the distance 6b between the means 3 and the means 15, shown only in FIG. 1.

In a particular embodiment, the distance 6a between the means 2a and the means 3a can be adjusted while the 3D printer is in operation. In this way, for example, an adaptation to different printing speeds and printing qualities can be achieved and particular physical process parameters such as the fluid behavior of the particulate building material 10 or the idle time of the space printed with particulate building material 10 can be addressed.

Furthermore, in the example illustrated in FIG. 2, an assembly 4c with a means 2b, which is also designed as a roller, and an assembly 4d with a means 3b, which is also designed as a blade, may be arranged.

In this embodiment, the distance 6a between the means 2b and the means 3b is also adjustable. In addition, the distance between the first coater subassembly 1a and the second coater subassembly 1b, which is not shown in FIG. 2, can also be set freely. The distance between the coater subassemblies 1a and 1b thus determines the distance between the means 3a and 2b.

Such a coater arrangement 1, consisting of a first coater sub-arrangement 1a and a second coater sub-arrangement 1b, makes it possible to produce a layer 11 consisting of two partial layers of the particulate building material 10, which is not shown in FIG. There is no restriction of the invention to just a first coater subassembly 1a in connection with a second coater subassembly 1b. For example, when three coater subassemblies 1a, 1b and 1c are arranged in a coater assembly 1, a layer 11 of the particulate building material 10 consisting of three sublayers can be produced.

FIG. 3 shows a perspective exemplary representation of the arrangement 1 according to the invention or the coater arrangement 1 from below with a means 2a for applying particulate building material 10 and with a plurality of means 3a, 3b and 3c arranged spatially separate from the means 2a for smoothing the particulate building material 10.

For better understanding, a further illustration of the arrangement from FIG. 3 is shown in FIG. 4. The following description can therefore apply to both FIGS. 3 and 4.

In this case, the means 2a is arranged in the first assembly 4a. The means 3a is arranged in the assembly 4b, the means 3b is arranged in the assembly 4d and the means 3c is arranged in the assembly 4e. As already explained in relation to FIG. 2, each assembly 4a, 4b, 4d and 4e also has components such as holding elements, drives, sensors, actuators and others, which will not be explained here in more detail.

The means 2a in the first assembly 4a is designed, for example, as a roller, via which the particulate building material 10 is uniformly applied to the building site 5, while the coater arrangement 1 moves evenly over the building site 5 to the left in the direction shown by the left arrow 16. Such means 2a with a roller for applying the building material 10 are known from the prior art.

During this movement over the construction site 5, the assemblies 4a, 4b, 4d and 4e are moved uniformly and together with the coater arrangement 1 in the same direction und in a virtual plane over the construction site 5, wherein the distances between the means 2a, 3a, 3b and 3c und their distances to the surface of the construction site 5 do not change while the coater arrangement 1 moves over the construction site 5.

When the coater arrangement 1 moves to the left, a first smoothing step 7 of the particulate building material 10 applied to the construction site 5 is carried out by the means 3a arranged in the assembly 4b, which is designed as a blade in the example in FIGS. 3 and 4. In the same movement of the coater arrangement 1, but taking place at a later time, a second smoothing step 8 is carried out with the blade 3b arranged in the assembly 4d and a third smoothing step 9 with the blade 3c arranged in the assembly 4e.

FIG. 5 illustrates schematically the smoothing of the particulate building material 10, divided into three smoothing steps 7, 8 and 9, in a movement of der coater arrangement 1 over the construction site 5.

The particulate building material 10, which was applied by a means 2 (not shown) for applying the particulate building material 10, is shown above a construction site 5. The three means 3a, 3b and 3c for smoothing the particulate building material 10 are moved simultaneously and uniformly over the construction site 5 in the direction of movement shown by the arrow 16.

A first smoothing step 7 is carried out with the means 3a, a second smoothing step 8 with the means 3b and a third smoothing step 7 with the means 3c, which in their sum provide the applied and smoothed particulate building material 10, i.e. a layer 11 applied according to the invention, not shown in FIG. 5.

Advantageously, the means 3a, 3b and 3c are arranged above the construction site 5 at an angle 12 relative to the vertical. Such an angle 12 has the effect that the means 3a, 3b and 3c not only smooth the building material 10, but also compact that the building material 10. This angle 12 can be in a range between −80° and +80°, in particular in a range between −20° and +20°.

Advantageously, the angle 12 may be set to have the same magnitude for all three means 3a, 3b and 3c. Alternatively, a different angle may be set for each of the means 3a, 3b and 3c.

Advantageously, the shape of the edge of the blade or of the squeegee can influence the compaction, the flow behavior and the positioning of the particulate building material.

FIG. 6 shows two spatially separate coater subassemblies 1a and 1b according to the invention above a construction site 5, as viewed obliquely from below, each coater subassembly having a means 2 for applying and a means 3 for smoothing particulate building material 10.

The coater subassembly 1a has a first assembly 4a, in which at least one means 2a for applying particulate building material 10 is arranged. The coater subassembly 1a also has a second assembly 4b, in which at least one means 3a for smoothing the applied particulate building material 10 is arranged. In the example of FIG. 6, the means 2a is a roller and the means 3a is a blade.

Immediately adjacent to the first coater subassembly 1a, the coater assembly 1 has a further coater subassembly 1b. The coater subassembly 1b has an assembly 4c in which at least one means 2b for applying particulate building material 10 is arranged. The coater subassembly 1b also has a further assembly 4d, in which at least one means 3b for smoothing the applied particulate building material 10 is arranged. In the example of FIG. 6, the means 2b is a roller and the means 3b is a blade.

The coater arrangement 1 can be moved over the construction site 5 in the directions shown by the arrows 16. As is known from the prior art, the distance between the coater arrangement 1 and the construction site 5 can also be changed by moving the coater arrangement 1. In this way, the distance from the construction site 5 can be increased or decreased.

As is common, when building up the layers, the coater arrangement 1 moves continuously upwards away from the construction site 5, and this movement can be controlled accordingly. It is thus possible to move the coater arrangement 1 away from the construction site 5 by the entire amount of the height of a generated layer 11. It is also possible to move the coater arrangement 1 away from the construction site 5 by only a fraction of the total height of a generated layer 11.

In the construction site 5 shown in FIG. 6, three layers 11a, 11 b and 11c have already been generated. The coater arrangement 1 is shown in a movement directed to the left in FIG. 6. During this movement, a first partial layer 13 is generated with the first coater subassembly 1a. The first partial layer 13 is generated by applying particulate building material 10 on the previously generated layer 11c with the means 2a (a roller) and smoothed with the means 3a (a blade).

In the same movement process of the coater arrangement 1, a second partial layer 14 is generated by means of the second coater subassembly 1b. The second partial layer 14 is generated by applying particulate building material 10 on the previously generated first partial layer 13 with the means 2b and smoothed with the means 3b.

With the coating arrangement 1 shown in FIG. 6, a complete layer 11 of the particulate building material 10 can be generated with the coater subassembly 1a or the coater subassembly 1b in a single movement of the coater arrangement 1 over the construction site 5, in the example depicted in FIG. 6 from right to left.

In a first alternative, a complete layer 11 of the particulate building material 10 can be generated by generating a first partial layer 13 with the first coater subassembly 1a in a movement of the coater arrangement 1 over the construction site 5 and thereafter generating a second partial layer 14 with the second coater subassembly 1b. In this case, the complete layer 11 is composed of identical or different proportions of the first partial layer 13 and the second partial layer 14.

In another alternative, a complete layer 11 of the particulate building material 10 can be generated by first generating with the first coater subassembly 1a in a movement of the coater arrangement 1 over the construction site 5 the entire thickness of the layer 11, using a first particulate building material 10a, and by subsequently generating with the second coater subassembly 1b a full thickness of layer 11, using a second particulate building material 10b. This process is shown in FIG. 6 in the already generated layer 11a. This process can be repeated as often as desired with changing particulate building material 10a and 10b. When the coater arrangement 1 has, for example, three coater subassemblies 1a, 1b and 1c, the layer 11 can be generated using three different particulate building materials 10a, 10b and 10c.

With the coater arrangement 1 according to the invention, the layer 11 can be generated both by using different particulate building materials 10 and by using a plurality of partial layers 13, 14 in a single movement of der coater arrangement 1 over the construction site 5, with no restriction to just two partial layers.

A portion of the possibilities feasible with the coater arrangement 1 when generating the layer 11 is shown in FIG. 6 in the layers 11a, 1b and 11c.

In each of the illustrated embodiments of the invention, a further means for compacting 15 the particulate building material 10 may be arranged in addition to the means 2 for applying the particulate building material 10 to a construction site 5 and the means 3 for smoothing the applied particulate building material 10.

### LIST OF REFERENCE SYMBOLS USED

1, 1a, 1b, . . . , 1n Arrangement for generating a layer of a particulate building material in a 3D printer/coater arrangement/coater subassembly
2, 2a, 2b, . . . , 2n Means for applying particulate building material/roller
3, 3a, 3b, . . . , 3n Means for smoothing particulate building material/blade
4, 4a, 4b, . . . , 4n Assembly
5 Construction site
6a, 6b Distance
7 First smoothing step
8 Second smoothing step
9 Third smoothing step
10, 10a, 10b, . . . , 10n Particulate building material
11, 11a, 11b, . . . , 11n Layer of particulate building material
12 Angle
13 First partial layer
14 Second partial layer
15 Means for compacting particulate building material
16 Arrow

1. Arrangement (1) for generating a layer (11) of a particulate building material (10) in a 3D printer, the arrangement (1) being movable over a construction site (5) and comprising: a first assembly (4a) having a device (2) for applying the particulate building material (10) to the construction site (5); and a second assembly (4b), which is arranged in the arrangement (1) technically separate and spatially separate from the first assembly (4a), having a device (3) for smoothing the applied particulate building material (10) are arranged.

2. The arrangement (1) according to claim 1, further comprising at least one further assembly (4d) having a device (3b) for smoothing the applied particulate building material (10) is arranged in the arrangement (1).

3. The arrangement (1) according to claim 1, further comprising: at least one further assembly (4c) having a device (2b) for applying the particulate building material (10) to the construction site (5) and a further assembly (4d) having a device (3b) for smoothing the applied particulate building material (10) are arranged in the arrangement (1).

4. The arrangement (1) according to claim 1, wherein the device (2) for applying the particulate building material (10) to the construction site (5) is a roller.

5. The arrangement (1) according to claim 1, wherein the device (3) for smoothing the particulate building material (10) is a blade.

6. The arrangement (1) according to claim 1, wherein the device (2) for applying the particulate material to the construction site (10) is arranged in the arrangement (1) at a distance (6a) from the device (3) for smoothing the particulate building material (10).

7. The arrangement (1) according to claim 1, further comprising a further assembly (4) having a device for compacting (15) the applied particulate building material (10) is arranged in the arrangement (1).

8. A method for generating a layer (11) of a particulate building material (10) in a 3D printer, in which for generating the layer (11) the particulate building material (10) is applied, smoothed and compacted to produce the layer (11), the method comprising the steps of: applying the particulate building material (10) to a construction site (5) with a coater arrangement (1) provided above the construction site (5) and movable over the construction site (5), and that in a second method step, which follows the first method step in time and which is independent of the first method step, smoothing the applied particulate building material (10), wherein the first and the second method steps are performed in a single movement of the coater arrangement (1) over the construction site (5).

9. The method according to claim 8, wherein the first method step for generating the layer (11) in the single movement of the coater arrangement (1) over the construction site (5), a first particulate building material (10a) and/or a second particulate building material (10b) is applied on the construction site (5).

10. The method according to claim 8, wherein in the first method step for generating the layer (11) in the single movement of the coater arrangement (1) over the construction site (5), at least a first partial layer (13) and a second partial layer (14) are applied.

11. The method according to claim 8, wherein in the second method step, the applied particulate building material (10) is smoothed by at least one first smoothing step (7) and by a second smoothing step (8) in the single movement of the coater arrangement (1) over the construction site (5).

12. The method according to in claim 8, further comprising: a third method step, which follows the first or second method step in time and which is independent of the first or second method step, compacting the applied particulate building material (10) or the applied and smoothed particulate building material (10).
